(19) United States
(12) Patent Application Publication
(10) Pub. No.: US 2017/0140260 A1
(43) Pub. Date: May 18, 2017

(54) CONTENT FILTERING WITH CONVOLUTIONAL NEURAL NETWORKS

(71) Applicant: RCRDCLUB Corporation, New York, NY (US)

(72) Inventors: Damian Franken Manning, New York, NY (US); Omar Emad Shams, Brooklyn, NY (US)

(21) Appl. No.: 15/354,377

(22) Filed: Nov. 17, 2016

Related U.S. Application Data
(60) Provisional application No. 62/256,614, filed on Nov. 17, 2015.

(51) Int. Cl. G06N 3/04; G10L 25/51; G06F 17/30; G10L 25/30

(52) U.S. Cl. CPC G06N 3/04; G10L 25/30; G10L 25/51; G06F 17/30761

(57) ABSTRACT

Systems and techniques are provided for content filtering with convolutional neural networks. A spectrogram generated from audio data may be received. A convolution may be applied to the spectrogram to generate a feature map. Values for a hidden layer of a neural network may be determined based on the feature map. A label for the audio data may be determined based on the determined values for the hidden layer of the neural network. The hidden layer may include a vector including the values for the hidden layer. The vector may be stored as a vector representation of the audio data.

### BACKGROUND

It may be difficult to select a song or video likely to be enjoyed by a user from a collection of songs or videos. Prior listening or viewing habits of the user can be used as an input to the selection process, as can consumption data about the song or video. For example, a song or video can be presented to a user and a system can determine if the user liked the song or video if the user selects a “like” indication after listening to the song or video. The profiles of users that have liked or listened to a song or liked or watched a video can be processed to look for common attributes. The song can then be presented to a user with similar attributes as those users that have listened to or liked the song or watched or liked the video.

Not all songs and videos have consumption data. For example, a newly released song or video has no consumption data and may have little consumption data for a period of time after its release. In such a situation, techniques that rely upon consumption data to predict which users will like a song or video may not be useful.

### BRIEF SUMMARY

According to an implementation of the disclosed subject matter, Systems and techniques are provided for content filtering with convolutional neural networks. A spectrogram generated from audio data may be received. A convolution may be applied to the spectrogram to generate a feature map. Values for a hidden layer of a neural network may be determined based on the feature map. A label for the audio data may be determined based on the determined values for the hidden layer of the neural network. The hidden layer may include a vector including the values for the hidden layer. The vector may be stored as a vector representation of the audio data.

Additional features, advantages, and implementations of the disclosed subject matter may be set forth or apparent from consideration of the following detailed description, drawings, and claims. Moreover, it is to be understood that both the foregoing summary and the following detailed description provide examples of implementations and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows an example system suitable for content filtering with convolutional neural networks according to an implementation of the disclosed subject matter.

FIG. 2 shows an example arrangement for content filtering with convolutional neural networks according to an implementation of the disclosed subject matter.

FIG. 3 shows an example arrangement for content filtering with convolutional neural networks according to an implementation of the disclosed subject matter.

FIG. 4 shows an example arrangement for content filtering with convolutional neural networks according to an implementation of the disclosed subject matter.

FIG. 5 shows an example arrangement for content filtering with convolutional neural networks according to an implementation of the disclosed subject matter.

FIG. 6 shows an example of a process for content filtering with convolutional neural networks according to an implementation of the disclosed subject matter.

FIG. 7 shows a computer according to an embodiment of the disclosed subject matter.

FIG. 8 shows a network configuration according to an embodiment of the disclosed subject matter.

### DETAILED DESCRIPTION

According to embodiments disclosed herein, a convolutional neural network can be trained based on acoustic information represented as image data and/or image data from a video. A song can be represented by a two dimensional spectrogram. For example, a song can be represented by a spectrogram that has thirteen (or more) frequency bands shown over thirty seconds of time. The spectrogram may be, for example, a mel-frequency cepstrum (MFC) representation of a 30 second song sample. A MFC can be a representation of the short-term power spectrum of a sound, based on a linear cosine transform of a log power spectrum on a nonlinear mel scale of frequency. A cepstrum may be obtained by taking the Inverse Fourier transform (IFT) of the logarithm of the estimated spectrum of a signal, for example according to:

Power cepstrum of signal=| [symbol] ⁻¹{log| [symbol] {f(t)}|²}|² (1)

The frequency bands may be equally spaced on the mel scale, which may approximate the human auditory system's response more closely than the linearly-spaced frequency bands used in the normal cepstrum. The frequency bands may be represented vertically in the two-dimensional spectrogram.

A one-dimensional convolution may be performed along the time axis of a spectrogram, for example by a convolutional layer of the convolutional neural network. The spectrogram may be, for example, an MFC, mel spectrogram, or any other suitable spectrogram, representing any suitable length of audio. For example, the spectrogram may be an MFC representing 30 seconds of a song. This one-dimensional convolution may smooth the spectrogram along the time axis and increase the signal to noise ratio. The one-dimensional convolution may be performed by any suitable filter, kernel, or feature detector, which may be implemented by the convolutional layer of the convolutional neural network. The one-dimensional convolution of the spectrogram may produce a feature map. The convolutional neural network may include any suitable number of convolutional layers, implementing any suitable filters, kernels, or feature detectors, which may be applied to the spectrogram in any suitable order, in any suitable combination of iteratively and consecutively. For example, a first convolutional layer may include two filters which may each produce a feature map. Each feature map may be further processed by the convolutional neural network, and a second convolutional layer may include three additional filters which may each produce a feature map from the two processed feature maps produced by the first convolutional layer. This may result in a total of six feature maps which may be input to additional layers of the convolutional neural network. The convolutional neural network may use any suitable convolutions implemented by any suitable convolutional layer. For example, the convolutional layer may implement a three-dimensional convolution.

The convolutional neural network may include a max pooling layer, which may apply a max pooling operation based on the maximum signal over a coarser partitioning over time of the spectrogram, for example, as represented by a feature map produced by the convolutional layer. The may pooling layer may, for example, receive as input a feature map produced from a spectrogram by the convolutional layer. The output of the max pooling layer may be, for example, a feature map with reduced dimensionality from the input feature map, resulting in the feature map being reduced in size. The convolutional neural network may also use any other suitable form of pooling, including, for example, average pooling, in place of or in conjunction with max pooling. The convolutional neural network may include any suitable number of max pooling layers, implanting any suitable filters, kernels, or feature detectors, which may be applied to the spectrogram in any suitable order, in any suitable combination of iteratively and consecutively. For example, a first max pooling layer may receive input from a first convolutional layer, and a second max pooling layer may receive input from a second convolutional layer after the first max pooling layer.

The convolutional neural network may include a dropout layer. The dropout layer may be used to avoid over-fitting. For example, the dropout layer may be a hidden layer of the convolutional neural network in which some of the units are dropped, for example, randomly, during training of the convolutional neural network, dropping the connections between the dropped units of the dropout layer and previous and subsequent layers. The dropout layer may be fully connected when used after training. The dropout layer may be connected between a max pooling layer and a fully connected hidden layer. The weights connecting the units of the dropout layer to previous and subsequent layers of the convolutional neural network may be determined during training of the convolutional neural network. The training may be, for example, supervised training using spectrogram inputs of sections of songs with known genres, and may be accomplished, for example, through backpropagation, or in any other suitable manner.

The convolutional neural network may include the hidden layer, which may be used in conjunction with an activation layer to identify the genre of a song based on the acoustic information contained in the MFC, mel spectrogram, or other spectrogram, that was input to the convolutional layer of the convolutional neural network. The input into the hidden layer may be the output of the dropout layer, for example, values of the units of the dropout layer, as processed through weighted connections. The weights of the connections between the hidden layer and the dropout layer and activation layer may be based on training of the convolutional neural network. The training may be, for example, supervised training using spectrogram inputs of sections of songs with known genres, and may be accomplished, for example, through backpropagation, or in any other suitable manner. In an implementation, the genre of a song may be determined based only on the acoustic information in the cepstrum for the song. The hidden layer may be output to an activation layer, for example, based on the values of the hidden layer and the weighted connections between the hidden layer and the activation layer. The activation layer may indicate a label, such as a genre, for the song from which the spectrogram was generated as determined by the convolutional neural network.

The convolutional neural network may use any number of convolution, max pooling, dropout, and hidden layers, and they may be applied in some implementations consecutively and in some implementations iteratively, as this may improve the overall quality of the resultant output of the convolutional neural network, for example, increasing categorization accuracy.

The same spectrogram, for example, MFC or mel spectrogram, may be input into any suitable number of convolutional neural networks. Different convolutional neural networks may have different numbers and types of convolutional, max pooling, dropout, and hidden layers, and may be trained to identify any suitable aspects of a song that may be determinable from a spectrogram of audio from the song. For example, a convolutional neural network may receive as input a mel spectrogram with log-scaled amplitude representing the entire audio of a song. This convolutional neural network may perform two dimensional convolutions on the mel spectrogram. This convolutional neural network may have been trained, for example, using latent vector representations of various songs from a Word2Vec model. This may allow the convolutional neural network to determine information about an input song in addition to genre, such as, for example, the gender of the vocalist, presence of instruments, and style of the song.

A latent representation of a song that has been processed through the convolutional neural network may be used as a vector representation of the acoustic properties of that song. For example, the latent representation of a song may be a hidden layer of the convolutional neural network after processing a spectrogram, such as an MFC or mel spectrogram, of a segment of the song. The hidden layer may be in the form of a vector including any suitable number of values over any suitable range. The vector may represent the acoustic properties of the song. Vectors representing a number of songs may be used in any suitable manner, for example, to order the songs on a playlist based on the acoustic properties of the songs as represented by their vectors. For example, the dot product of two vectors, representing two songs, may be used to determine how similar the songs are based on their acoustic properties. This may result in acoustic smoothing of playlists, and may allow for the amplification in playlist of unique acoustic properties of songs that may be particularly desirable to a listener. The vector representing a song may be taken from any suitable hidden layer of the convolutional neural network. The use of the vector representation of a song may allow, for example, a new song to be inserted into a playlist of older songs in an intelligent manner, for example, in a way that may make a listener more likely to enjoy the new song due to acoustic similarities to surrounding songs on the playlist. The vector representation may be used in conjunction with other suitable models that may pick songs that are typically listened to together. In some implementations, songs may be selected that have acoustic properties that users naturally group together for consumption.

Implementations of the convolutional neural network can advantageously select songs likely to be enjoyed by a listener or set of listeners, even for songs for which there is no consumption data available. For instance, new releases and songs by new artists can be more accurately selected as songs likely to be enjoyed by a given listener. This can advantageously help to solve the cold start problem for new music.

A convolutional neural network may be used on videos, such as, for example, music videos. A video may be represented by a random sampling of two-dimensional images from the video. The video can be a music video whose soundtrack may be a particular song, or may be any other type of video. The two-dimensional images from the video may be filtered by a convolutional layer of the convolutional neural network, for example, using a blur filter, which may limit the detail in the two dimensional images. The convolutional neural network may use a max pooling layer and a dropout layer in addition to any filtering of the two-dimensional images by any convolutional layers of the convolutional neural network. For two-dimensional images from a music video, a final layer of a convolutional neural network, for example, a hidden layer, may be trained to identify the genre of a music video based on features in the two-dimensional images from the music video in conjunction with an activation layer. The latent representation in the convolutional neural network of the two dimensional images from a music video, for example, as represented by the hidden layer of the convolutional neural network, may be appended to the hidden layer of the convolutional neural network trained to identify the genre of a song, for example, from a music video, based on the acoustic information contained in the MFC for the song. The vector object resulting from the appending of the vectors representations from the two hidden layers may allow the hidden layers to be used together or separately to filter media items, such as songs, both with music videos and separate from music videos.

For two-dimensional images from non-music videos, such as, for example, movies and television shows, a final layer of a convolutional neural network, for example, a hidden layer, can be trained to identify the genre, or other classifications regarding latent and emergent visual properties of the video, based on features in the two-dimensional images from the video, in conjunction with an activation layer.

The latent representation of each video in the convolutional neural network, for example, a hidden layer or layers of the convolutional neural network, may be used as a vector representation of the visual properties of that video. With a vector that represents the visual properties of a set of videos, the visual vector model may be used in ensemble with other models to provide visual smoothing and amplify unique features that may be particularly desirable to the viewer. For example, the dot product of the vector representations of two videos may be used to determine a level of similarity between the videos, which may then be used to order the videos on a playlist in an intelligent manner, for example, providing smoother visual transitions between videos. This model can be used in conjunction with models that pick videos that are typically watched together. Implementations can also select videos that have visual properties that users naturally group together for consumption.

Implementations can advantageously select videos likely to be enjoyed by a viewer or set of viewers, even for videos for which there is no consumption data available. For example, new releases and videos by new artists may be more accurately selected as videos likely to be enjoyed by a given viewer. This can advantageously help to solve the cold start problem for new video.

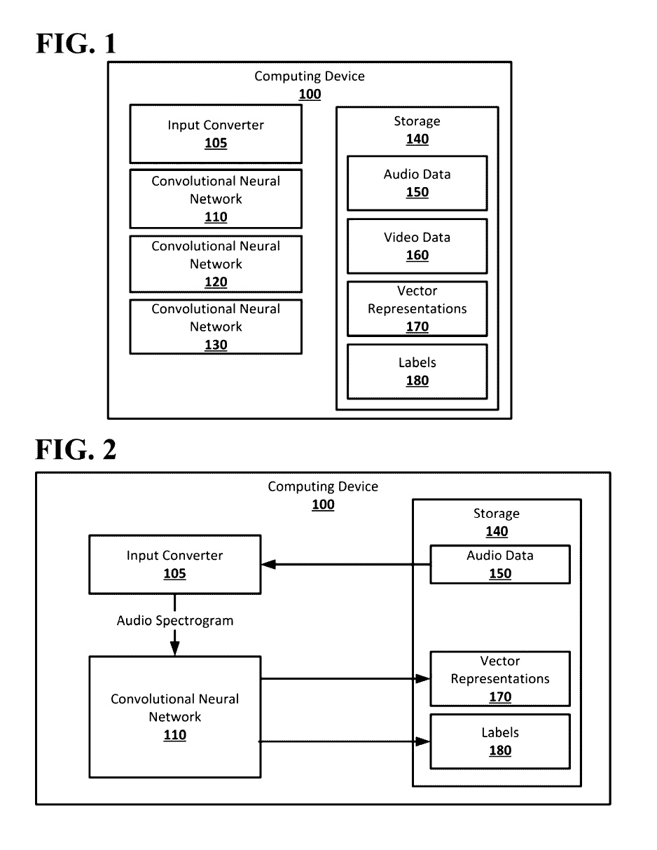

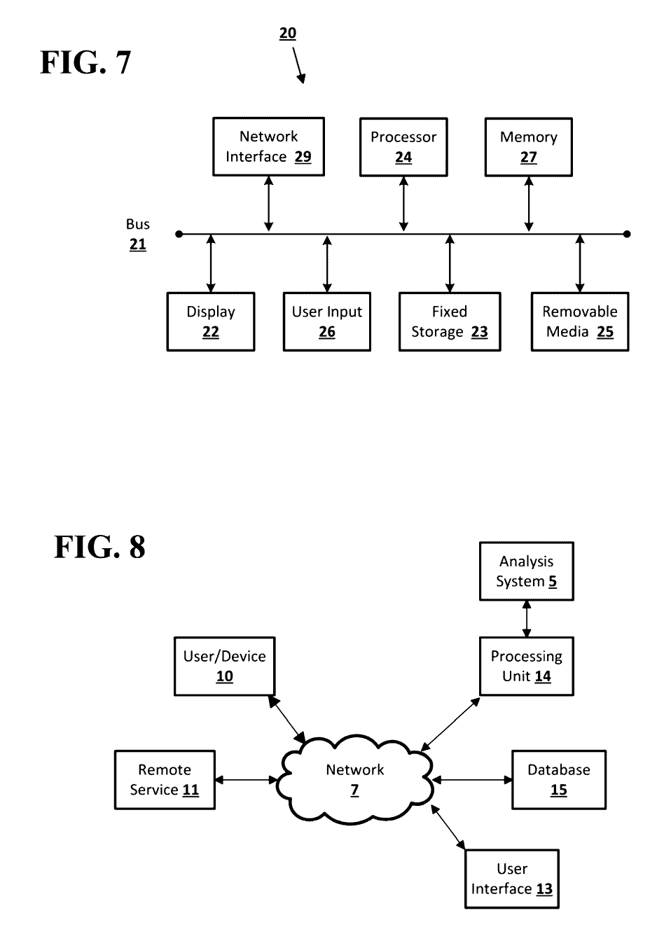

FIG. 1 shows an example system suitable for content filtering with convolutional neural networks according to an implementation of the disclosed subject matter. A computing device 100 may include an input converter 105, convolutional neural networks 110, 120, and 130, and a storage 140. The computing device 100 may be any suitable device, such as, for example, a computer 20 as described in FIG. 7, for implementing the input converter 105, the convolutional neural networks 110, 120, and 130, and the storage 140. The computing device 100 may be a single computing device, or may include multiple connected computing devices. The input converter 105 may convert input, such as, for example, audio data 150 and video data 160, into an appropriate format to be input into a neural network, such as, for example, the convolutional neural networks 110, 120, and 130. The storage 140 may store the audio data 150, video data 160, vector representations 170, and labels 180 in any suitable manner.

The input converter 105 may be any suitable combination of hardware and software for converting input, such the audio data 150 and the video data 160, into a suitable format for use with the convolutional neural networks 110, 120, and 130. For example, the input converter 105 may use the audio data 150, which may be, for example, a song, to generate an MFC, mel cepstrum, or other audio spectrogram, for example, representing audio data as a two-dimensional image. The input converter 105 may use the video data 160, which may be, for example, a video such as a music video, to generate two-dimensional images based on the image data in the video at various points in time in the video.

The convolutional neural networks 110, 120, and 130 may be any suitable neural networks which may be stored and implemented in any suitable manner on the computing device 100. The convolutional neural networks 110, 120, and 130 may use any suitable neural network architectures, including, for example, any suitable number of convolutional layers, max pooling layers, dropout layers, and hidden layers, connected in any suitable manner. Different convolutional neural networks may use different architectures, including different numbers and arrangements of the different types of layers. The convolution layers may implement any suitable filters, kernels, or feature detectors, and may implement, for example, one, two, or three dimensional convolutions. The dropout layers may have any suitable dropout ratio and pattern during training. Any suitable number of rectified linear units (RELUs) may be used as a nonlinear activation function for the output of any suitable layer of the convolutional neural networks 110, 120, and 130. The computing device 100 may implement any suitable number of convolutional neural networks, such as the convolutional neural networks 110, 120, and 130, and convolutional neural networks may be added, removed, and modified on the computing device 100.

The convolutional neural networks 110, 120, and 130 may be trained in any suitable manner. For example, the convolutional neural network 110 may be trained to identify the genre of a song based on a spectrogram of a segment of the song. The convolutional neural network 110 may be trained using supervised training on a corpus of spectrograms from songs with known genres. In some implementations, a convolutional neural network, such as the convolutional neural networks 110, 120, and 130, may be trained using a Word2Vec model, which may allow the convolutional neural network to identify additional features of a song, such as, for example, genre, style, gender of vocalists, presence of various instruments, and so on. Convolutional neural networks may also be trained to identify various aspects of videos, for example, based on still images from the videos.

The audio data 150 may be, for example, a song or other suitable audio clip. The audio data 150 may be stored in any suitable format, with any suitable encoding or compression. The video data 160 may be, for example, a video, such as a music video or other video, and may be stored in any suitable format, with any suitable encoding or compression. In some implementations, the audio data 150 and the video data 160 may be associated, for example, with the audio data 150 being an audio track that can be played back with images in the video data 160, for example, as part of music video or other video.

The vector representations 170 may be vector representations of data, such as audio data 150 or video data 160, that was input to a convolutional neural network, such as one of the convolutional neural networks 110, 120, and 130. A vector representation in the vector representations 170 may be, for example, a vector of values from the hidden layer from the convolutional neural network 110, after the hidden layer has processed input, such as spectrogram created from audio data 150. The hidden layer may be a vector including any suitable number of values over any suitable range. The vector representation for the audio data 150 may, for example, represent acoustic properties of the audio data 150, which may be, for example, a song. The vector representations 170 may be associated with or linked to the data, such as the audio data 150 or video data 160, which they represent, in any suitable manner. For example, a database may track the association between vector representations 170 and the audio data 150 or video data 160 which they represent. A vector representation may be stored as metadata for the audio data 150 or video data 160 which it represents, for example, in a metadata tag attached to a file that includes a song or video.

The labels 180 may be labels determined by convolutional neural networks, such as the convolutional neural networks 110, 120, and 130, for the audio data 150 and video data 160. For example, the convolutional neural network 110 may determine a genre for the audio data 150. The determined genre may be stored in the labels 180 as a label for the audio data 150. Any label determined by a convolutional neural network on the computing device 100 for any data, such as the audio data 150 and the video data 160, may be stored in the labels 180. Multiple labels may be determined for the same data, such as, for example, for the audio data 150. For example, the audio data 150 may be a song, and the convolutional neural network 120 may determine multiple labels which may relate to different aspects of the song, such as, for example, style, genre, gender of vocalists, and presence of instruments. The labels 180 may be associated with or linked to the data, such as the audio data 150 or video data 160, which they represent, in any suitable manner. For example, a database may track the association between vector representations 170 and the audio data 150 or video data 160 which they represent. A label may be stored as metadata for the audio data 150 or video data 160 for which the label was determined, for example, in a metadata tag attached to a file that includes a song or video.

FIG. 2 shows an example arrangement for content filtering with convolutional neural networks according to an implementation of the disclosed subject matter. The input converter 105 may receive, as input, the audio data 150. The audio data 150 may be, for example, a song or segment of a song, or other suitable audio. The input converter 105 may convert the audio data 150 to an audio spectrogram, such as, for example, a MFC or mel spectrogram, in any suitable manner. For example, the input converter 105 may convert a 30 second segment of the audio data 150 into an MFC by taking the Inverse Fourier transform (IFT) of the logarithm of the estimated spectrum of a signal of the audio data 150. The audio spectrogram may be a two-dimensional image representing the audio data 150 or segment thereof.

The convolutional neural network 110 may receive as input the audio spectrogram, for example, MFC or mel cepstrum, generated by the input converter 105 from the audio data 150. The convolutional neural network 110 may process the audio spectrogram through the various layers, for example convolutional, max pooling, dropout, and hidden layers, of the convolutional neural network 110. The convolutional neural network 110 may output, at its activation layer, a label for the audio data 150 based on the audio spectrogram. The label may identify, for example, the genre of a song in the audio data 150. The label may be output for storage with the labels 180 in the storage 140, and may be associated or linked to the audio data 150 in any suitable manner, allowing for the label to be retrieved in conjunction with the audio data 150. A hidden layer of the convolutional neural network 110 may be stored with the vector representations 170. The stored hidden layer may be any suitable hidden layer or layers from the neural network 110, including, for example, the last hidden layer before the activation layer. The hidden layer may be a vector that includes any suitable number of values over any suitable range. The hidden layer may be a vector representation of acoustic properties of the audio data 150 as determined from the audio spectrogram, and may be associated or linked to the audio data 150 in any suitable manner, allowing for the vector representation to be retrieved in conjunction with the audio data 150.

The video data 160 may be processed similarly by a convolutional neural network on the computing device 100. The convolutional neural network may generate a label for the video from the video data, for example, identifying a genre or style of the music video, to be stored with the labels 180. A vector of a hidden layer of the convolutional neural network may be stored as a vector representation of the visual properties of the video data 160 with the vector representations 170.

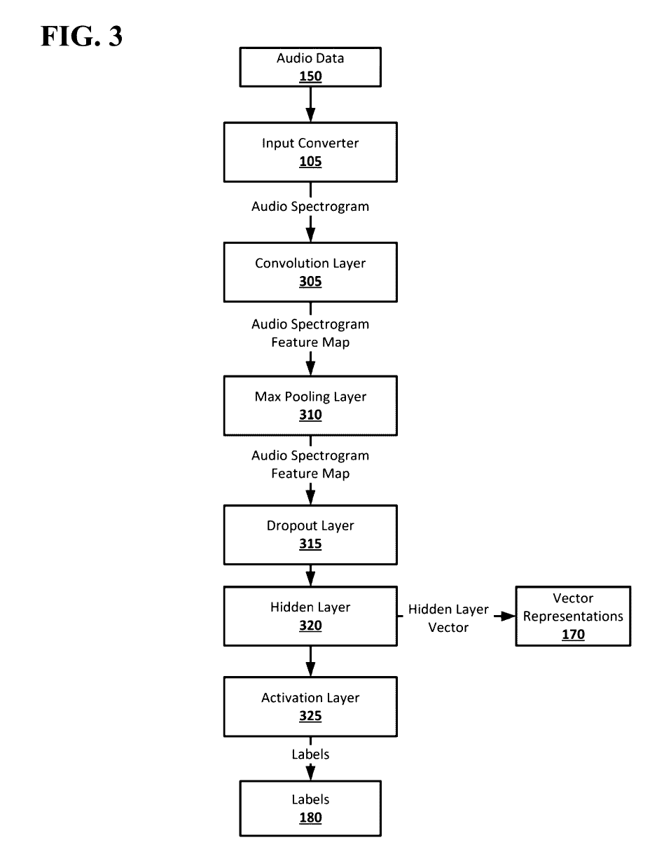

FIG. 3 shows an example arrangement for content filtering with convolutional neural networks according to an implementation of the disclosed subject matter. The audio data 150 may be input to the input converter 105. The input converter 105 may generate an audio spectrogram from the audio data 150. For example, the input converter 105 may generate an MFC from the audio data 150 by taking the Inverse Fourier transform (IFT) of the logarithm of the estimated spectrum of a signal of the audio data 150.

The audio spectrogram generated by the input converter 105 may be input to a convolutional neural network, such as the convolutional neural network 110. The audio spectrogram may be input to a convolution layer 305 of the convolutional neural network 110. The convolution layer 305 may be implemented in any suitable manner on the computing device 100, and may implement any suitable filter, kernel, or feature detector. The convolution layer 305 may generate a feature map for the audio spectrogram. In some implementations, the convolution layer 305 may implement more than one filter, kernel, or feature detector, and may generate more than one feature map from the audio spectrogram.

The audio spectrogram feature map generated by the convolution layer 305 may be input to a max pooling layer 310 of the convolutional neural network 110. The max pooling layer 310 may be implemented in any suitable manner on the computing device 100, and may implement any suitable pooling. The max pooling layer 310 may, for example, reduce the size of the audio spectrogram feature map.

The audio spectrogram feature map, after being reduced by the max pooling layer 310, may be input to a dropout layer 315 of the convolutional neural network 110 from the max pooling layer 310. The dropout layer 315 may be implemented in any suitable manner on the computing device 100, such as, for example, a vector, and may include units which were temporarily dropped during training of the convolutional neural network 110.

The output of the dropout layer 315 may be input to a hidden layer 320, which may be a fully connected hidden layer of the convolutional neural network 110. The hidden layer 320 may be implemented in any suitable manner on the computing device 100, such as, for example, as a vector with associated weights of the weighted connections between the hidden layer 320 and the dropout layer 315 stored in any suitable manner. A vector used to implement the hidden layer may represent acoustic properties of the audio data 150, and may be stored with the vector representations 170.

The output of the hidden layer 320 may be input to an activation layer 325, which may be a layer of the convolutional neural network 110 whose values may be translated into labels for the audio data 150. For example, the values of the activation layer 325 may be translated to a label indicating the genre of a song in the audio data 150. The weights of the weighted connections between the hidden layer 320 and the activation layer 325 may be stored in any suitable manner, including as a vector. The label output by the activation layer 325 may be stored with the labels 180.

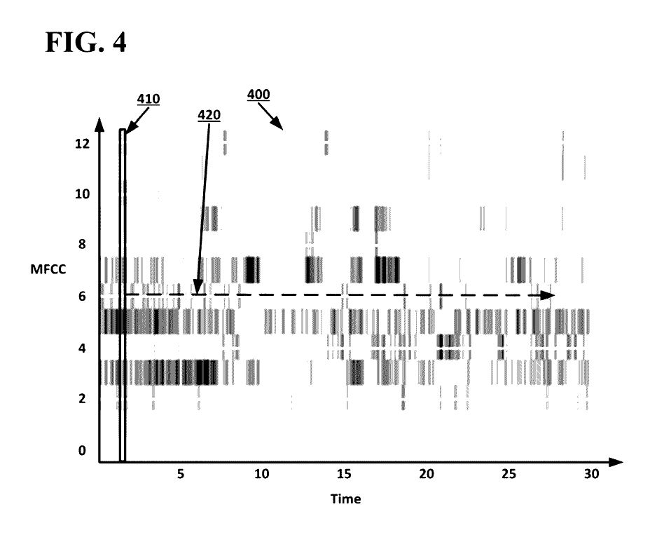

FIG. 4 shows an example arrangement for content filtering with convolutional neural networks according to an implementation of the disclosed subject matter. An audio spectrogram 400 may be generated by the input converter 105 from the audio data 150. The audio data 150 may be, for example, a song, and the audio spectrogram 400 may represent, for example, the Mel-frequency cepstral coefficients of a 30 second segment of the song. The convolution layer 305 may implement, for example, a one-dimensional convolution using a filter 410, which may process the audio spectrogram 400 may move along path 420. The output of the filter 410 may be used to generate the feature map from the audio spectrogram 400.

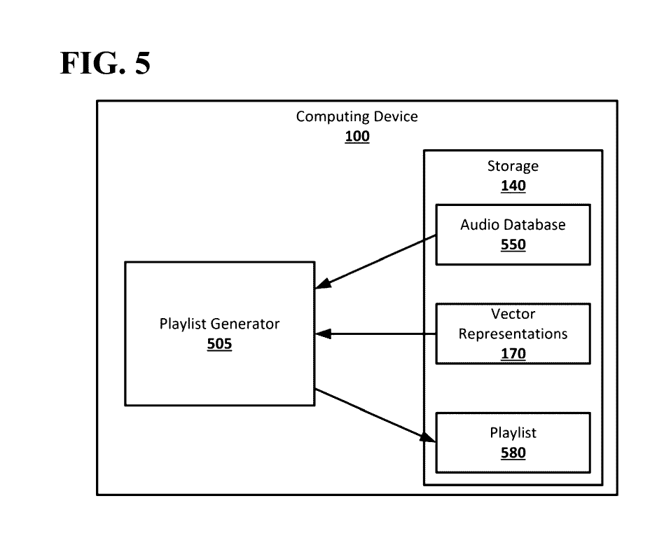

FIG. 5 shows an example arrangement for content filtering with convolutional neural networks according to an implementation of the disclosed subject matter. The computing device 100 may include a playlist generator 505. The storage 140 may store an audio database 550 and a playlist 580. The playlist generator 505 may be any suitable combination of hardware and software for generating playlists of songs, such as the playlist 580. The audio database 550 may be a database including any suitable number of songs. The audio database 550 may include the audio data for the songs along with metadata, or may only include metadata for the songs, such as, for example, bibliographic information for the songs such as artist name, album and song titles, record label names, year of release, data on user consumption of the songs, such as, for example, number of plays by some group of users and ratings of the songs by some group of users, labels assigned to the songs by convolutional neural networks, such as, for example, genre, and vector representations for the song, for example, as generated by the convolutional neural networks 110, 120, and 130.

The playlist generator 505 may generate the playlist 580 by, for example, using a vector representation from the vector representations 170 and vector representations of the songs in the audio database 550. For example, the audio data 150 may be a new song for which no user consumption data is available. The vector representation of the new song may be stored with the vector representations 170 after the audio data 150 is processed through the input converter 105 and the convolutional neural network 110. The playlist generator 505 may compare the acoustic properties of the new song, as represented by the vector representation of the new song, to the acoustic properties of a catalog of songs included in the audio database 550, for example, by taking the dot product of the vector representation of the new song and the vector representations of songs in the audio database 550. This may allow the playlist generator 505 to generate the playlist 580, which may include the new song placed along with a number of songs from the audio database 550 based on the comparisons of acoustic properties. The playlist 580 may be acoustically smoothed, as the new song may be placed on the playlist 580 near songs from the audio database 550 with similar acoustic properties, as determined through the dot product of vector representations. The playlist generator 505 may generate the playlist 580 using any available songs from the audio database 550, or may be limited, for example, to ordering a particular selection of songs from the audio database 550 along with the new song. For example, 15 songs may be selected from the audio database for use on the playlist 580 with the new song, and playlist generator 505 may use the dot product of the vector representations to determine the order in which to place the 16 total songs on the playlist 580.

Similarly, the playlist generator 505 may use a vector representation of the video data 160 along with vector representations of other videos to generate a playlist that includes a video from the video data 160 along with other videos. The comparison of vector representations may allow for smoother visual transmissions between videos on the generated playlist.

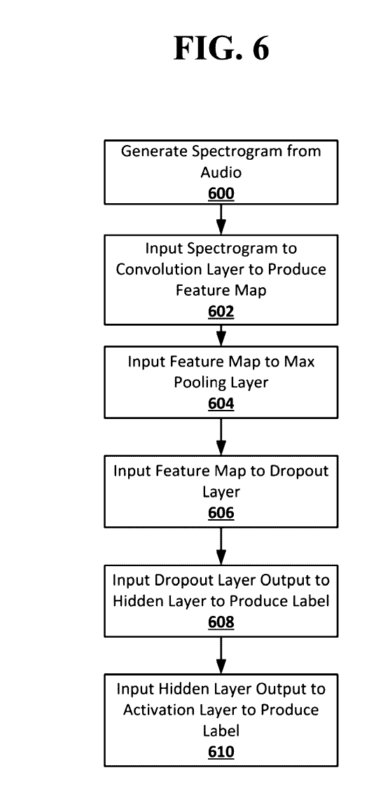

FIG. 6 shows an example of a process for content filtering with convolutional neural networks according to an implementation of the disclosed subject matter. At 600, a spectrogram may be generated from audio. For example, the input converter 105 may generate a spectrogram, such as the audio spectrogram 400, from the audio data 150.

At 602, the spectrogram may be input to a convolution layer to produce a feature map. For example, the audio spectrogram 400 may be input to the convolution layer 305 of the convolutional neural network 110. The convolution layer 305 may implement any suitable filter, kernel, or feature detector, such as, for example, the filter 410, of any suitable dimensionality, on the audio spectrogram 400. This may produce a feature map from the audio spectrogram 400.

At 604, the feature map may be input to a max pooling layer. For example, the feature map produced by the convolution layer 305 may input to the max pooling layer 310 of the convolutional neural network 110. The max pooling layer 310 may, for example, reduce the dimensionality, or size of the feature map.

At 606, the feature map may be input to the dropout layer. For example, the feature map, after being reduced by the max pooling layer 310, may be input to the dropout layer 315 of the convolutional neural network 110. The dropout layer 315 may be a fully connected hidden layer which may have had units temporarily dropped during training of the convolutional neural network 110. The dropout layer 315 may be connected to the max pooling layer 310 with weighted connections.

At 608, output from the dropout layer may be input to a hidden layer. For example, the dropout layer 315 may be fully connected the hidden layer 320 of the convolutional neural network 110 with weighted connections. The hidden layer 320 may be a fully connected hidden layer of the convolutional neural network 110. The hidden layer 320 may be a vector, which may be stored as a vector representation of the acoustic properties of the song in the audio data 150.

At 610, output from the hidden layer may be input to an activation layer. For example, the hidden layer 320 may be fully connected the activation layer 325 of the convolutional neural network 110 with weighted connections. The activation layer 325 may be a layer of the convolutional neural network 110 whose values may be translated into the output of the convolutional neural network 110 in the form of a label. The label may, for example, identify the genre of the song in the audio data 150.

Implementations of the presently disclosed subject matter may be implemented in and used with a variety of component and network architectures. FIG. 7 is an example computer 20 suitable for implementations of the presently disclosed subject matter. The computer 20 includes a bus 21 which interconnects major components of the computer 20, such as a central processor 24, a memory 27 (typically RAM, but which may also include ROM, flash RAM, or the like), an input/output controller 28, a user display 22, such as a display screen via a display adapter, a user input interface 26, which may include one or more controllers and associated user input devices such as a keyboard, mouse, and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks, as shown in FIG. 8.

Many other devices or components (not shown) may be connected in a similar manner (e.g., document scanners, digital cameras and so on). Conversely, all of the components shown in FIG. 7 need not be present to practice the present disclosure. The components can be interconnected in different ways from that shown. The operation of a computer such as that shown in FIG. 7 is readily known in the art and is not discussed in detail in this application. Code to implement the present disclosure can be stored in computer-readable storage media such as one or more of the memory 27, fixed storage 23, removable media 25, or on a remote storage location.

FIG. 8 shows an example network arrangement according to an implementation of the disclosed subject matter. One or more clients 10, 11, such as local computers, smart phones, tablet computing devices, and the like may connect to other devices via one or more networks 7. The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A computer-implemented method performed by a data processing apparatus, the method comprising:
receiving a spectrogram generated from audio data;
applying a convolution to the spectrogram to generate a feature map;
determining values for a hidden layer of a neural network based on the feature map; and
determining a label for the audio data based on the determined values for the hidden layer of the neural network.

2. The computer-implemented method of claim 1, wherein the hidden layer comprises a vector comprising the values for the hidden layer, and further comprising:
storing the vector as a vector representation of the audio data.

3. The computer-implemented method of claim 1, wherein determining a label for the audio data based on the determined values for the hidden layer of the neural network further comprises determining values for an activation layer of the neural network based on the determined values for the hidden layer of the neural network.

4. The computer-implemented method of claim 1, wherein the spectrogram is a mel spectrogram or a mel-frequency cepstrum.

5. The computer-implemented method of claim 1, wherein applying a convolution comprises applying to the spectrogram one or more of: a one-dimensional convolution, a two-dimensional convolution, and a three-dimensional convolution.

6. The computer-implemented method of claim 1, wherein the neural network comprises a convolutional neural network trained to identify a genre of a song based on a spectrogram generated from the song, and wherein the label identifies a genre of a song in the audio data.

7. The computer-implemented method of claim 2, further comprising:
receiving, for one or more songs, a vector representation for each of the one or more songs;
comparing the vector representation of the audio data to the vector representations for each of the one or more songs; and
generating a playlist comprising one or more of the one or more songs and a song represented by the audio data based on the comparing of the vector representation of the audio data to the vector representations for each of the one or more songs.

8. The computer-implemented method of claim 1, wherein comparing the vector representation of the audio data to the vector representations for each of the one or more songs comprises determining the dot products of the vector representation of the audio data and the vector representations for each of the one or more songs.

9. A computer-implemented system for content filtering with convolutional neural networks, comprising:
a storage comprising audio data; and
a processor that implements a convolutional neural network that receives a spectrogram generated from audio data, applies a convolution to the spectrogram to generate a feature map, determines values for a hidden layer of the convolutional neural network based on the feature map, and determines a label for the audio data based on the determined values for the hidden layer of the neural network.

10. The computer-implemented system of claim 9, wherein the hidden layer comprises a vector comprising the values for the hidden layer, and wherein the processor that implements the convolutional neural network further stores the vector in the storage as a vector representation of the audio data.

11. The computer-implemented system of claim 9, wherein the processor implementing the convolutional neural network further determines a label for the audio data based on the determined values for the hidden layer of the neural network further by determining values for an activation layer of the neural network based on the determined values for the hidden layer of the neural network.

12. The computer-implemented system of claim 9, wherein the spectrogram is a mel spectrogram or a mel-frequency cepstrum.

13. The computer-implemented system of claim 9, wherein the processor implementing the convolutional neural network applies a convolution by applying to the spectrogram one or more of: a one-dimensional convolution, a two-dimensional convolution, and a three-dimensional convolution.

14. The computer-implemented system of claim 9, wherein the convolutional neural network is trained to identify a genre of a song based on a spectrogram generated from the song, and wherein the label identifies a genre of a song in the audio data.

15. The computer-implemented system of claim 10, wherein the processor further receives, for one or more songs, a vector representation for each of the one or more songs, compares the vector representation of the audio data to the vector representations for each of the one or more songs, and generates a playlist comprising one or more of the one or more songs and a song represented by the audio data based on the comparing of the vector representation of the audio data to the vector representations for each of the one or more songs.

16. The computer-implemented system of claim 9, wherein the processor compares the vector representation of the audio data to the vector representations for each of the one or more songs by determining the dot products of the vector representation of the audio data and the vector representations for each of the one or more songs.

17. A system comprising: one or more computers and one or more storage devices storing instructions which are operable, when executed by the one or more computers, to cause the one or more computers to perform operations comprising:
receiving a spectrogram generated from audio data;
applying a convolution to the spectrogram to generate a feature map;
determining values for a hidden layer of a neural network based on the feature map; and
determining a label for the audio data based on the determined values for the hidden layer of the neural network.

18. The system of claim 17, wherein the instructions further cause the one or more computers to perform operations comprising:
storing the vector as a vector representation of the audio data.

19. The system of claim 17, wherein the instructions further cause the one or more computers to perform operations comprising:
receiving, for one or more songs, a vector representation for each of the one or more songs;
comparing the vector representation of the audio data to the vector representations for each of the one or more songs; and
generating a playlist comprising one or more of the one or more songs and a song represented by the audio data based on the comparing of the vector representation of the audio data to the vector representations for each of the one or more songs.

20. The system of claim 17, wherein the instructions that cause the one or more computer to perform operations comprising comparing the vector representation of the audio data to the vector representations for each of the one or more songs further cause the one or more computers to perform operations comprising determining the dot products of the vector representation of the audio data and the vector representations for each of the one or more songs.
